(19) United States
(12) Patent Application Publication
(10) Pub. No.: US 2025/0392353 A1
(43) Pub. Date: Dec. 25, 2025

(54) Devices and methods for coordinated transmission in a wireless network

(71) Applicant: HUAWEI TECHNOLOGIES CO., LTD., Shenzhen (CN)

(72) Inventors: Genadiy Tsodik, Hod Hasharon (IL); Arik Klein, Hod Hasharon (IL); Shimon Shilo, Hod Hasharon (IL); Oded Redlich, Hod Hasharon (IL)

(73) Assignee: HUAWEI TECHNOLOGIES CO., LTD., Shenzhen (CN)

(21) Appl. No.: 19/281,073

(22) Filed: Jul. 25, 2025

Related U.S. Application Data
(63) Continuation of application No. PCT/EP2023/052035, filed on Jan. 27, 2023.

(51) Int. Cl. H04B 7/024

(52) U.S. Cl. CPC H04B 7/024

(57) ABSTRACT

A sharing access point (AP) configured to share a transmission opportunity (TXOP) with a plurality of shared APs operating under a coordination agreement within a multi-AP (M-AP) set for participating in a coordinated transmission to one or more non-AP stations associated with the sharing AP and a plurality of further non-AP stations associated with the shared APs. The sharing AP is configured to receive completion status information indicative of a completion status of transmitting information related to an operation under the coordination agreement to one or more of the plurality of further non-AP stations associated with the respective shared AP. Moreover, the sharing AP is configured, based on the completion status information of each of the one or more of the plurality of shared APs, to generate and maintain a data structure indicating the completion status for each of the plurality of shared APs.

### CROSS-REFERENCE TO RELATED APPLICATIONS

This application is a continuation of International Application No. PCT/EP2023/052035, filed on Jan. 27, 2023, the disclosure of which is hereby incorporated by reference in its entirety.

### TECHNICAL FIELD

The present disclosure relates to wireless communications. More specifically, the present disclosure relates to devices and methods for coordinated transmission in a wireless communication network, in particular an IEEE 802.11-based WLAN.

### BACKGROUND

IEEE 802.11-based WLANs (also referred to as Wi-Fi networks) have become popular at an unprecedented rate. 802.11be discussed a Multi AP (M-AP) coordinated transmission, for instance, a coordinated beamforming transmission. In a coordinated transmission a group of access points (APs) may initiate concurrent frame exchange within a limited time period while using the entire BW by each participating AP and one or more APs of the group of APs may share one or more transmission opportunities (TXOPs), including a sharing AP and one or more shared APs. The group of APs that have decided to cooperate in order to perform coordinated transmissions is called an M-AP set.

### SUMMARY

The present disclosure provides improved devices and methods for M-AP coordinated transmission in a wireless communication network, in particular an IEEE 802.11 based WLAN.

According to a first aspect, a sharing access point, AP, is provided, wherein the sharing AP is configured to share at least a portion of a transmission opportunity, TXOP, it has obtained with a plurality of shared APs operating under a coordination agreement within a Multi-AP, M-AP, set for participating in a coordinated transmission to one or more non-AP stations associated with the sharing AP and a plurality of further non-AP stations associated with the plurality of shared APs. The sharing AP comprises a communication interface configured to receive completion status information, in particular a completion station information frame from one or more of the plurality of shared APs, wherein the completion status information frame received from each of the one or more of the plurality of shared APs is indicative of a completion status of successfully transmitting information related to an operation under the coordination agreement to one or more of the plurality of further non-AP stations associated with the respective shared AP. Moreover, the sharing AP comprises a processing circuitry configured, based on the completion status information frame of each of the one or more of the plurality of shared APs, to generate and maintain a data structure, wherein the data structure indicates the completion status for each of the plurality of shared APs. In an implementation form, the data structure may also indicate the completion status for the sharing AP of successfully transmitting information related to an operation under the coordination agreement to the one or more non-AP stations associated with the sharing AP.

In a further possible implementation form, the communication interface is configured to transmit the data structure to each of the plurality of shared APs, in particular before the end of a current transmission opportunity.

In a further possible implementation form, the communication interface is configured to transmit an Indication Status frame to the plurality of shared APs, wherein the indication frame comprises the data structure.

In a further possible implementation form, the Indication Status frame further comprises an address, in particular a MAC address and/or an identifier of the sharing AP and/or of each of the plurality of shared APs.

In a further possible implementation form, the Indication Status frame further comprises a M-AP set identifier indicative of the M-AP set.

In a further possible implementation form, the Indication Status frame further comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the data structure comprises an indication of the completion status for each of the plurality of shared APs as well as the sharing AP operating under the same coordination agreement.

In a further possible implementation form, the data structure comprises, i.e. is implemented as a look-up table.

In a further possible implementation form, the communication interface is further configured to transmit one or more M-AP trigger frames, in particular one or more M-AP trigger frames for Intra-BSS indication, to one or more of the plurality of shared APs for triggering, i.e. soliciting the respective shared AP to provide the information related to an operation under the coordination agreement to the one or more further non-AP stations associated with the respective shared AP.

In a further possible implementation form, the communication interface is configured to transmit the one or more M-AP trigger frames to the one or more of the plurality of shared APs, for which the data structure indicates that the respective shared AP has not completed the Intra-BSS related procedure, e.g. that the respective shared AP has not completed transmitting the information related to the operation under the coordination agreement to the one or more of the plurality of further non-AP stations associated with the respective shared AP yet, for triggering the respective shared AP to provide the information related to an operation under the coordination agreement to the one or more further non-AP stations of the plurality of further non-AP stations associated with the respective shared AP.

In a further possible implementation form, the one or more M-AP trigger frames comprise an address, in particular a MAC address and/or an identifier of the sharing AP and/or of each of the plurality of shared APs.

In a further possible implementation form, the one or more M-AP trigger frames comprise a M-AP set identifier indicative of the M-AP set.

In a further possible implementation form, the one or more M-AP trigger frames comprise a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the processing circuitry is configured to restrict the coordinated transmission to those of the plurality of shared APs, from which the sharing AP has indicated their status information as “completed”, and those of the plurality of shared APs for which the data structure indicates the completion status as “completed”.

In a further possible implementation form, the information related to an operation under the coordination agreement comprises a M-AP set identifier indicative of the M-AP set.

In a further possible implementation form, the information related to an operation under the coordination agreement comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the information related to an operation under the coordination agreement comprises an address, in particular a MAC address and/or an identifier of each of the plurality of shared APs.

In a further possible implementation form, the sharing AP further comprises a memory, wherein the memory is configured to store the data structure.

According to a second aspect a method of operating a sharing access point, AP, is provided, wherein the sharing AP is configured to share at least a portion of a transmission opportunity, TXOP, it has obtained with a plurality of shared APs operating under a coordination agreement within a Multi-AP, M-AP, set for participating in a coordinated transmission to one or more non-AP stations associated with the sharing AP and a plurality of further non-AP stations associated with the plurality of shared APs. The method comprises the steps of:

receiving completion status information, in particular a completion status information frame, from one or more of the plurality of shared APs, wherein the completion status information frame received from each of the one or more of the plurality of shared APs is indicative of a completion status of successfully transmitting information related to an operation under the coordination agreement to one or more of the plurality of further non-AP stations associated with the respective shared AP; and
generating and maintaining, based on the completion status information frame of each of the one or more of the plurality of shared APs operating under this coordination agreement, a data structure, wherein the data structure indicates for each of the plurality of shared APs the completion status. In an implementation form, the data structure may also indicate the completion status for the sharing AP of successfully transmitting information related to an operation under the coordination agreement to the one or more non-AP stations associated with the sharing AP.

The method according to the second aspect of the present disclosure can be performed by the sharing AP according to the first aspect of the present disclosure. Thus, further features of the method according to the second aspect of the present disclosure result directly from the functionality of the sharing AP according to the first aspect of the present disclosure as well as its different implementation forms described above and below.

According to a third aspect a shared access point, AP, is provided, wherein the shared AP is configured to participate in a coordinated transmission to one or more non-AP stations associated with the shared AP and one or more further non-AP stations associated with a sharing AP making use of at least a portion of a transmission opportunity, TXOP, obtained and shared by the sharing AP operating under a coordination agreement within a Multi-AP, M-AP, set. The shared AP comprises a communication interface configured to transmit information related to an operation under the coordination agreement to the one or more non-AP stations associated with that shared AP, i.e. the BSS stations of the shared AP. The communication interface is further configured to transmit completion status information, in particular a completion status information frame to the sharing AP, wherein the completion status information frame is indicative of a completion status of successfully transmitting the information related to an operation under the coordination agreement to the one or more non-AP stations associated with the respective shared AP.

In a further possible implementation form, the communication interface is further configured to receive a data structure from the sharing AP, wherein the data structure indicates for the sharing AP and for each of a plurality of further shared APs operating under the coordination agreement within the M-AP set the completion status of transmitting the information related to an operation under the coordination agreement to one or more non-AP stations associated with the sharing AP and the respective further shared AP.

In a further possible implementation form, the communication interface is configured to receive an Indication Status frame from the sharing AP, wherein the Indication Status frame comprises the data structure.

In a further possible implementation form, the Indication Status frame further comprises an address, in particular a MAC address and/or an identifier of the sharing AP and/or of the shared AP.

In a further possible implementation form, the Indication Status frame further comprises a M-AP set identifier indicative of the M-AP set.

In a further possible implementation form, the Indication Status frame further comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the data structure comprises an indication of the completion status for the sharing AP and each of the plurality of shared APs operating under the same coordination agreement.

In a further possible implementation form, the data structure comprises, i.e. is implemented as a look-up table.

In a further possible implementation form, the communication interface is configured to provide the information related to an operation under the coordination agreement to the one or more non-AP stations associated with that shared AP, i.e. the BSS stations of the shared AP, following the reception of a M-AP trigger frame, in particular a M-AP trigger frame for Intra-BSS indication, from the sharing AP.

In a further possible implementation form, the M-AP trigger frame comprises an address, in particular a MAC address and/or an identifier of the sharing AP and/or of each of the plurality of shared APs.

In a further possible implementation form, the M-AP trigger frame comprises a M-AP set identifier indicative of the M-AP set.

In a further possible implementation form, the M-AP trigger frame comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the information related to an operation under the coordination agreement comprises a M-AP set identifier indicative of the M-AP set.

In a further possible implementation form, the information related to an operation under the coordination agreement comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the information related to an operation under the coordination agreement comprises an address, in particular a MAC address and/or an identifier of each of the plurality of shared APs operating under the same coordination agreement within the M-AP set.

In a further possible implementation form, the shared AP further comprises a memory, wherein the memory is configured to store the data structure.

In a further possible implementation form, the communication interface is further configured to receive an acknowledgement message, in particular an acknowledgement frame, from each of the one or more non-AP stations associated with the shared AP, in response to transmitting the information related to an operation under the coordination agreement to the one or more non-AP stations associated with the shared AP, i.e. the BSS stations of the shared AP.

According to a fourth aspect a method of operating a shared access point, AP, is provided, wherein the shared AP is configured to participate in a coordinated transmission to one or more non-AP stations associated with the shared AP and one or more further non-AP stations associated with a sharing AP making use of at least a portion of a transmission opportunity, TXOP, obtained and shared by the sharing AP operating under a coordination agreement within a Multi-AP, M-AP, set. The method comprises the steps of:

transmitting information related to an operation under the coordination agreement to the one or more non-AP stations associated with the shared AP, i.e. the BSS stations of the shared AP; and
transmitting completion status information, in particular a completion status information frame to the sharing AP, wherein the completion status information frame is indicative of a completion status of successfully transmitting the information related to an operation under the coordination agreement to the one or more non-AP stations associated with the respective shared AP.

The method according to the fourth aspect may further comprise receiving a M-AP trigger frame from the sharing AP and transmitting the information related to an operation under the coordination agreement to the one or more non-AP stations associated with the shared AP following, in particular in response to the reception of the M-AP trigger frame from the sharing AP.

The method according to the fourth aspect of the present disclosure can be performed by the shared AP according to the third aspect of the present disclosure. Thus, further features of the method according to the fourth aspect of the present disclosure result directly from the functionality of the shared AP according to the third aspect of the present disclosure as well as its different implementation forms described above and below.

According to a fifth aspect a non-access point, non-AP, station associated with a shared AP is provided, wherein the shared AP is configured to participate in a coordinated transmission to the non-AP station associated with the shared AP and a plurality of further non-AP stations associated with the shared AP or a sharing AP making use of at least a portion of a transmission opportunity, TXOP, obtained and shared by the sharing AP operating under a coordination agreement within a Multi-AP, M-AP, set. The non-AP station comprises a communication interface configured to receive information related to an operation under the coordination agreement from the shared AP. The communication interface is further configured to send an acknowledgment, in particular an acknowledgement frame, to the shared AP, in response to successfully receiving the information related to an operation under the coordination agreement from the shared AP.

In a further possible implementation form, the information related to an operation under the coordination agreement comprises a M-AP set identifier indicative of the M-AP set.

In a further possible implementation form, the information related to an operation under the coordination agreement comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

In a further possible implementation form, the information related to an operation under the coordination agreement comprises an address, in particular a MAC address and/or an identifier of each of the plurality of shared APs.

According to a sixth aspect a method of operating a non-access point, non-AP, station associated with a shared AP is provided, wherein the shared AP is configured to participate in a coordinated transmission to the non-AP station associated with the shared AP and a plurality of further non-AP stations associated with the shared AP or a sharing AP making use of at least a portion of a transmission opportunity, TXOP, obtained and shared by the sharing AP operating under a coordination agreement within a Multi-AP, M-AP, set. The method comprises the steps of:

receiving information related to an operation under the coordination agreement from the shared AP; and
sending an acknowledgment, in particular an acknowledgement frame, to the shared AP, in response to receiving the information related to an operation under the coordination agreement from the shared AP.

The method according to the sixth aspect of the present disclosure can be performed by the non-AP station according to the fifth aspect of the present disclosure. Thus, further features of the method according to the sixth aspect of the present disclosure result directly from the functionality of the non-AP station according to the fifth aspect of the present disclosure as well as its different implementation forms described above and below.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

Fig. 1 shows an exemplary wireless communication network including a sharing AP and a plurality of shared APs for coordinated transmission according to an embodiment;

FIG. 2 shows schematically the structure of a M-AP frame used by a sharing AP according to an embodiment for communicating with a shared AP according to an embodiment for a coordinated transmission, wherein the M-AP frame includes a coordination agreement identifier and a M-AP set identifier;

FIG. 3a shows different processing stages of M-AP coordinated operation including coordinated transmissions implemented by a conventional sharing AP and a conventional shared AP;

FIG. 3b shows different processing stages of M-AP coordinated operation including coordinated transmissions implemented by a sharing AP according to an embodiment and a shared AP according to an embodiment;

FIG. 4 shows a schematic diagram illustrating a data structure maintained and distributed by a sharing AP according to an embodiment;

FIG. 5 shows a schematic diagram illustrating signalling between a sharing AP according to an embodiment and two shared APs according to an embodiment prior to a coordinated transmission;

FIG. 6 shows a schematic illustrating signalling between a sharing AP according to an embodiment and three shared APs according to an embodiment for different coordinated transmissions, in particular transmission opportunities with different sharing APs;

FIG. 7 shows a schematic diagram illustrating signalling between a sharing AP according to an embodiment and two shared APs according to an embodiment prior to a coordinated transmission;

FIG. 8 shows a schematic diagram illustrating signalling between a sharing AP according to an embodiment, a shared AP according to an embodiment and a plurality of non-AP stations associated with the shared AP according to an embodiment;

FIG. 9 is a flow diagram illustrating a method of operating a sharing AP according to an embodiment;

FIG. 10 is a flow diagram illustrating a method of operating a shared AP according to an embodiment; and

FIG. 11 is a flow diagram illustrating a method of operating a non-AP station according to an embodiment associated with a shared AP.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

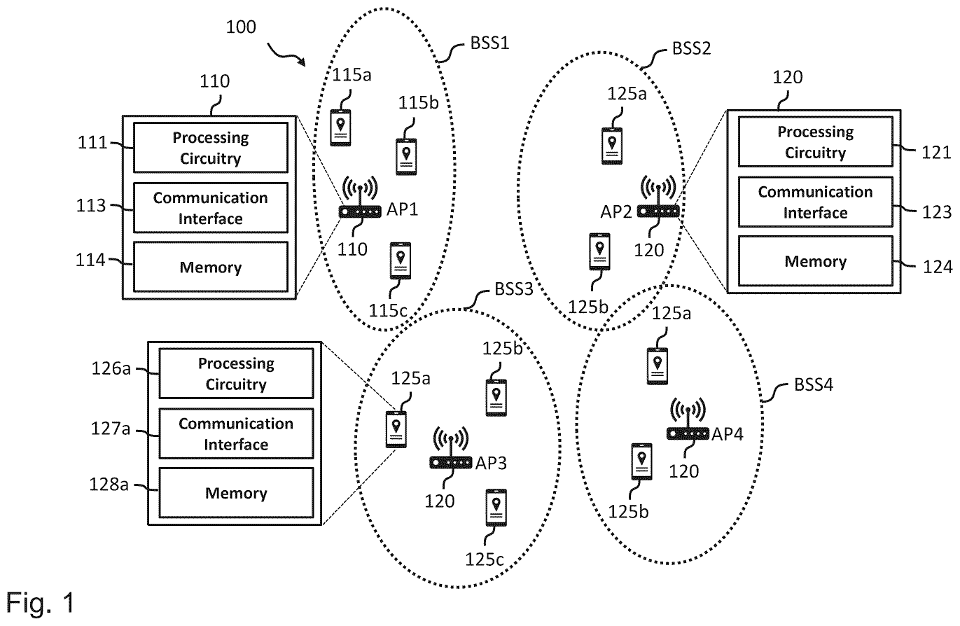

FIG. 1 shows an exemplary wireless communication network 100 including a sharing AP 110 with a plurality of associated non-AP stations 115a-c and a plurality of shared APs 120 with a respective plurality of associated non-AP stations 125a-c for coordinated transmission according to an embodiment. Each of the plurality of APs 110, 120 defines a respective Basic Service Set (BSS), as indicated in FIG. 1. As will be appreciated and will be described in more detail below, being the sharing AP and the shared AP can be considered roles or functions that in the exemplary scenario shown in FIG. 1 are provided by the sharing AP 110 and the shared APs 120, but may be reversed for a further coordinated transmission periods. In other words, in a further coordinated transmission period (i.e. in another obtained TXOP) one of the APs 120 may act as the sharing AP, while the AP 110 is one of the shared APs.

The wireless communication network 100 may be a WLAN in accordance with the IEEE 802.11 framework of standards (also referred to as a Wi-Fi network 100). Although, by way of example, three shared APs 120 are shown in FIG. 1 with their associated non-AP stations 125a,b and 125a-c, embodiments disclosed herein may be implemented with a more or less than three shared APs 120.

By way of example, the sharing AP 110 and the shared APs 120 illustrated in FIG. 1 may implement a coordinated beamforming transmission scheme (also referred to as CoBF transmission). As will be appreciated, however, embodiments disclosed herein may be implemented with other types of coordinated transmission schemes as well. CoBF transmission is a coordination scheme proposed for next generation Wi-Fi for simultaneous data transmission by several APs. This coordination scheme assumes that each participating AP has the capability to precode its transmitted signal such that mutual interference between this AP and the STAs of the OBSS (Overlapping BSS) during coordinated transmission is minimized (also referred to as nulling). Similarly to all other coordination schemes, CoBF is initialized by a sharing AP that proposes other APs (referred to as shared APs) to transmit simultaneously. The proposed resources in this case are spatial streams, where the sharing AP assigns a specific respective number of spatial streams to each shared AP. CoBF may make use of an additional sounding procedure for estimating the channels between the APs and the non-AP stations. Based on the estimated channels the APs may construct precoder matrices for generating beams and nulls toward the non-AP stations that participate in the current CoBF transmissions.

The sharing AP 110 shown in FIG. 1 is configured to share at least a portion of its obtained transmission opportunity, TXOP, with the shared APs 120 operating under the same coordination agreement within a Multi-AP set (also referred to as M-AP set) for participating in a coordinated transmission, for instance a coordinated beamforming transmission. As illustrated in FIG. 1, the sharing AP 110 comprises a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The sharing AP 110 may further comprise a memory 114 configured to store executable program code which, when executed by the processing circuitry 111, causes the sharing AP 110 to perform the functions and methods described herein.

Likewise, the each of the shared APs 120 illustrated in FIG. 1 comprises a processing circuitry 121 and a communication interface 123, in particular a wireless communication interface 123 in accordance with the IEEE 802.11 framework of standards. The processing circuitry 121 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. Each shared AP 120 may further comprise a memory 124 configured to store executable program code which, when executed by the processing circuitry 121, causes the shared AP 120 to perform the functions and methods described herein.

Likewise, each non-AP station, such as the exemplary non-AP station 125a illustrated in FIG. 1 comprises a processing circuitry 126a and a communication interface 127a, in particular a wireless communication interface 127a in accordance with the IEEE 802.11 framework of standards. The processing circuitry 126a may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The exemplary non-AP station 125a may further comprise a memory 128a configured to store executable program code which, when executed by the processing circuitry 126a, causes the exemplary non-AP station 125a to perform the functions and methods described herein.

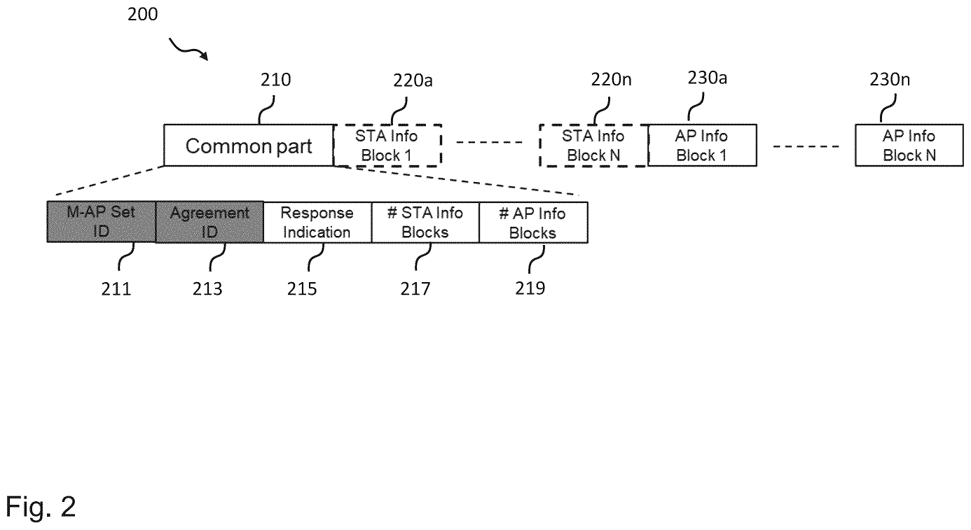

Several coordinated transmission schemes may involve communication between the APs 110, 120 and their OBSS stations 115a-c, 125a-c, i.e. between the APs 110, 120 and the non-AP stations 115a-c, 125a-c associated with other APs. For example, as already described above, for CoBF transmission an AP 110, 120 may perform a sounding procedure and may request sounding feedback reports both from the non-AP stations associated with it as well as the non-AP stations associated with other APs (also referred to as OBSS, i.e. Overlapping non-AP stations). This may be accomplished by a so-called Multi-AP, M-AP, frame 200 illustrated in FIG. 2. As illustrated in FIG. 2, such a M-AP frame 200 may include a M-AP Set ID (identifier) 211 and a coordination agreement ID (identifier) 213 within a common part 210 of the M-AP frame 200 to be exchanged among APs operating under the same coordination agreement within the same M-AP set. These parameters allow the receiver to recognize and respond to the M-AP frame 200. In addition to the common part 210 the M-AP frame 200 may include a STA info block 220a-n for each of the non-AP stations of the M-AP set and an AP info block 230a-n for each AP of the M-AP set. As illustrated in FIG. 2, the common part 210 of the M-AP frame 200 may further comprise an indication block 215 about the desired response to the M-AP frame 200 as well as blocks 217, 219 indicative of the number of STA info blocks 220a-n and AP info blocks 230a-n of the M-AP frame 200.

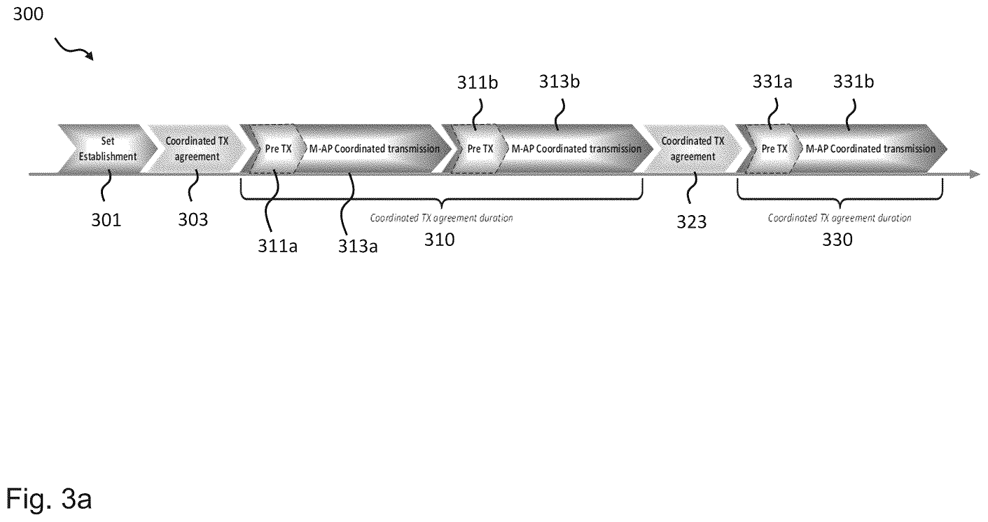

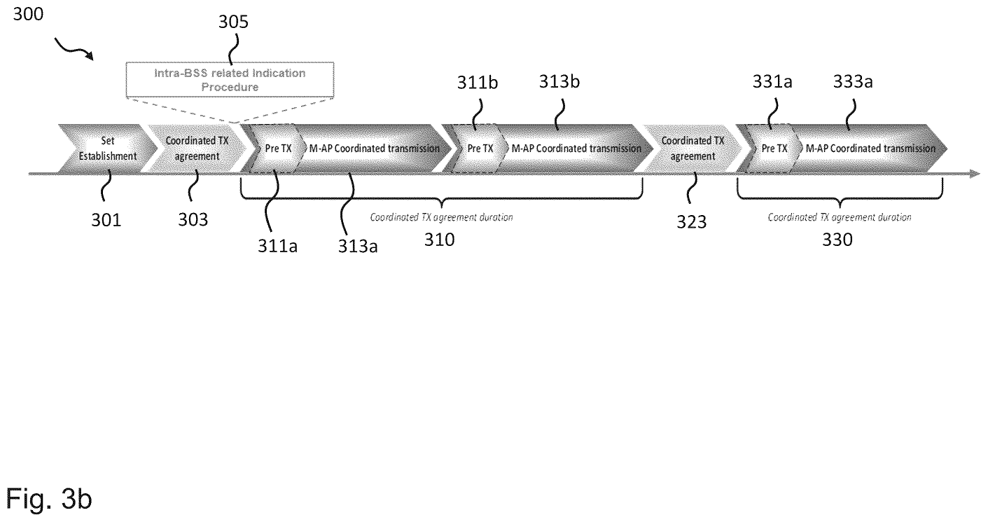

FIG. 3a illustrates a conventional M-AP coordinated transmission scheme 300. The M-AP coordinated transmission scheme 300 shown in FIG. 3a comprise the following main stages. In a stage 301 a set of APs is determined to participate in the coordinated transmission (this set is referred to as the Multi-AP or M-AP set). In a coordinated transmission agreement stage 303 all or a subset of the member APs of the M-AP set agree to share each obtained TXOP or part of thereof with at least one other member AP operating under the same agreement. The coordination agreement may last for several TXOPs, where specific participants (Shared APs) may be exchanged among TXOPs. As already described above, each TXOP may be obtained by a different AP (referred to as the sharing AP) while all the other APs, i.e. the shared APs may transmit during this TXOP (or part of thereof) only when triggered to do so by the sharing AP. The sharing AP decides how to share the resources and with which APs in the current TXOP (this may be announced by the sharing AP and approved by the shared APs).

As generally illustrated in FIG. 3b and described in more detail in the following, embodiments disclosed herein provide a managed procedure 305 (referred to as Intra-BSS related Indication Procedure in FIG. 3b) that allows the sharing AP 110 and the shared AP(s) 120 to complete indicating the associated non-AP stations 115a-c, 125a-c of each AP 110, 120 operating under the same coordination agreement within an allocated time period. Moreover, embodiments disclosed herein allow providing each AP 110, 120 of the M-AP set with the information about whether each AP 110, 120 of the M-AP set has completed the indication or has not completed the indication yet. As illustrated in FIG. 3b, the procedure 305 may be performed once prior to the one or more shared TXOPs coordinated transmissions, such as prior to the shared TXOPs coordinated transmissions 313a and 313b and prior to the shared TXOPs coordinated transmission 333a.

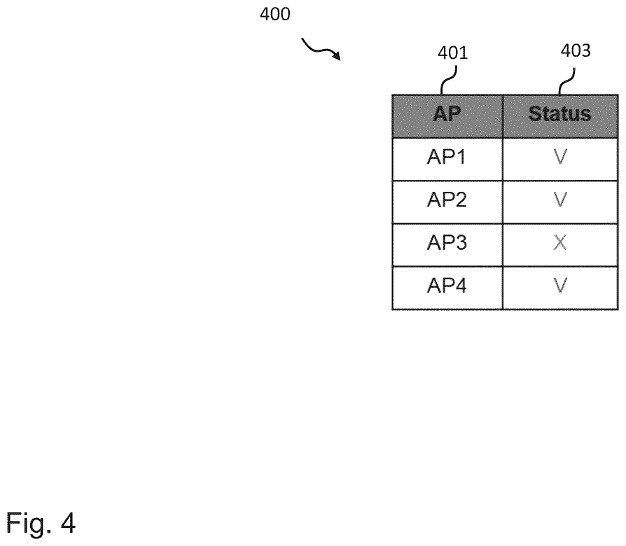

Embodiments disclosed herein are based on the idea of exchanging information between the sharing AP 110 and the shared AP(s) 120 of the M-AP set, for instance, by means of the data structure 400, in particular look-up table 400 illustrated in FIG. 4, which is managed by all the APs 110, 120 of the M-AP set that are operating under the same coordination agreement so that each AP 110, 120 as member of the coordination agreement owns its local copy of the data structure 400.

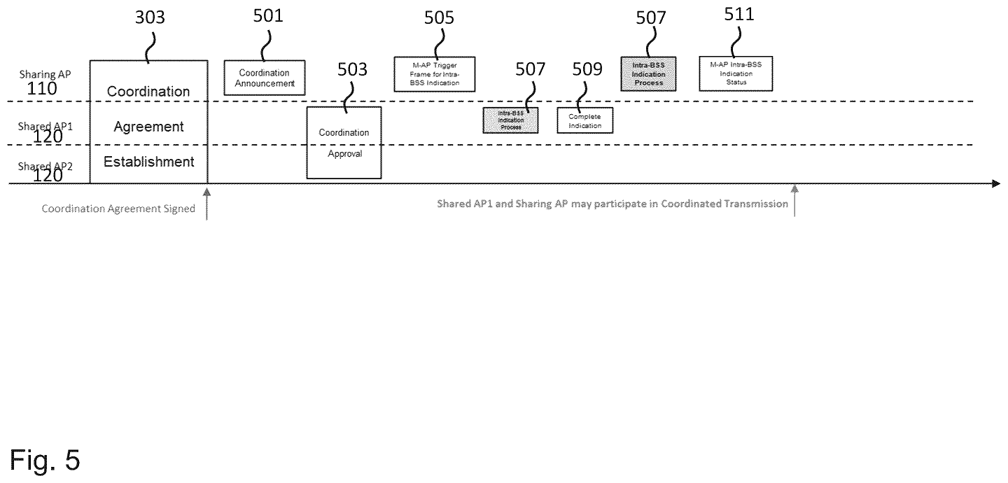

Thus, as illustrated in FIG. 5, the communication interface 113 of the sharing AP 110 is configured to receive completion status information frame 509 from, for instance, the shared AP1 120. As illustrated in FIG. 5, the completion status information 509 may be part of a completion status information frame 509 transmitted by the shared AP1 120 to the sharing AP 110. As illustrated in FIG. 3, prior to the completion status information frame 509 the sharing AP 110 and the shared APs 120 may have established a coordination agreement in a stage 303 (as already described above). The sharing AP 110 may transmit a coordination announcement frame 501 and receive, in response, coordination approvals 503 from the shared APs 120. Then, the sharing AP 110 may transmit a M-AP trigger frame 505 (which may have similar content as the M-AP frame 200 illustrated in FIG. 2, such as one or more identifiers) to the shared API 120 for triggering the shared AP1 120 to transmit information related to an operation under the coordination agreement to one or more of its non-AP stations, which pertain to its BSS.

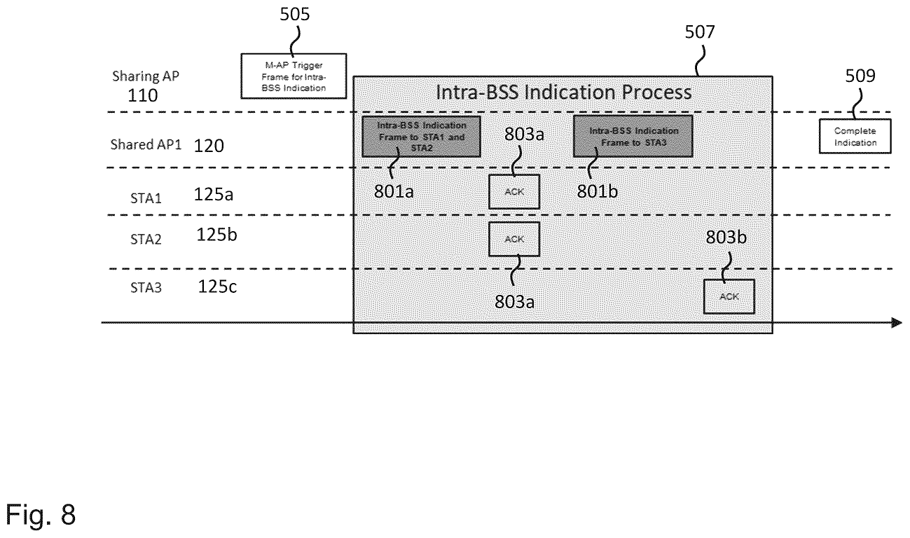

This operation is shown in more detail in FIG. 8. The sharing AP 110 transmits a M-AP trigger frame 505 (which may have a similar content as the M-AP frame 200 illustrated in FIG. 2, such as one or more identifiers) to the shared AP1 120 for triggering the shared AP1 120 to transmit information related to an operation under the coordination agreement to one or more of its non-AP stations 125a-c. In response to receiving the M-AP trigger frame 505 the shared AP1 120 (as part of the Intra-BSS indication process 507) transmits an Intra-BSS indication frame 801a to its associated non-AP stations 125a,b and receives acknowledgment frames 803a in response thereto. At a later stage the shared AP1 120 (still as part of the Intra-BSS indication process 507) may transmit a further Intra-BSS indication frame 801b to its associated non-AP station 125c and receive an acknowledgment frame 803b in response thereto. Once the shared AP1 120 has received the acknowledgment frames 803a,b from all of its associated non-AP stations 125a,c it transmits the completion status information frame 509 to the sharing AP 110 for informing the sharing AP 110 that the information related to an operation under the coordination agreement has been successfully transmitted to the non-AP stations 125a-c associated with the shared AP1 120. In other words, the completion status information frame 509 is indicative of a completion status of transmitting the information 801a,b related to the operation under the coordination agreement to the non-AP stations 125a-c associated with the shared AP1 120.

As illustrated in FIG. 5, the sharing AP 110 may perform the same Intra-BSS indication process 507 as the shared AP1 120 (illustrated in FIG. 8 and described above) with its associated non-AP stations 115a-c, i.e. transmit information related to an operation under the coordination agreement to one or more of its non-AP stations 115a-c. Based on these Intra-BSS indication processes 507 performed by the sharing AP 110 and the shared APs 120, the sharing AP 110 may generate and maintain a data structure, such as the look-up table 400 shown in FIG. 4, indicating the completion status for each of the plurality of shared APs 120. As illustrated in FIG. 4, the look-up table 400 may contain a column 401 for identifying the AP and a column 403 indicative of the completion status of transmitting the information related to the operation under the coordination agreement to the non-AP stations associated with the respective AP. By means of the M-AP Intra-BSS Indication Status frame 511 illustrated in FIG. 5 the sharing AP 110 may be configured to provide the current version of the data structure 400 to the plurality of shared APs 120.

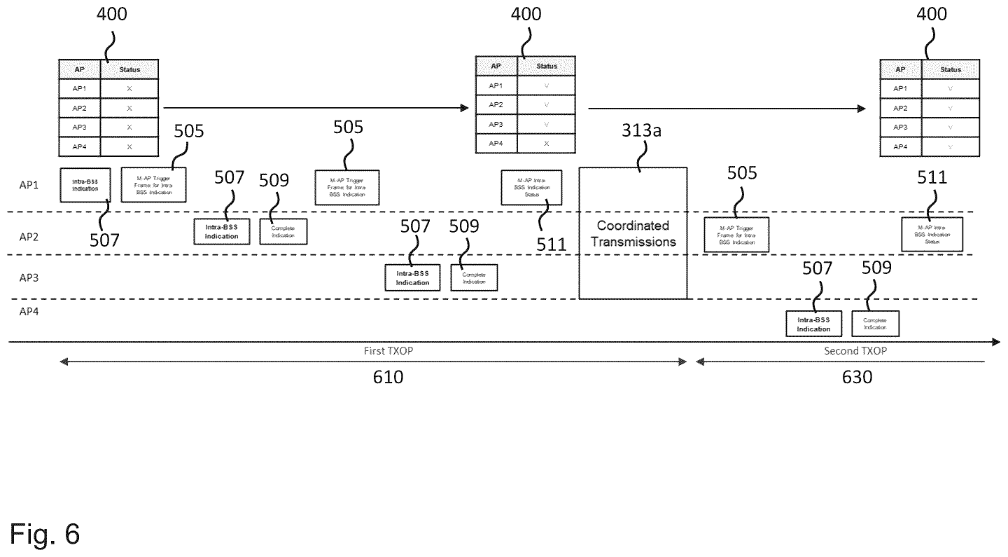

As will be described in the following under further reference to FIG. 6, each AP member of the coordination agreement, i.e. the sharing AP 110 and the shared APs 120 may maintain a local copy of the completion status look-up table 400. In an embodiment, only the shared APs 120 having the status “completed” may participate in the coordinated transmission(s). If the sharing AP 110 wants to include any shared APs 120 that have the status “not completed” in the coordinated transmission, it may initiate the Intra-BSS related indication procedure described above in the context of FIG. 5 with those shared APs prior to the initiation of the coordinated transmission. As illustrated in FIG. 6, at the end of the first TXOP 610, the sharing AP 110 may send by means of the frame 511 an update of the completion status look-up table 400 to all the shared APs 120 to ensure that all local copies of the table 400 are up to date. In an embodiment, the sharing AP 110 may trigger all the shared APs 120 that have the status “not completed” to finish the Intra-BSS indication process 507 illustrated in detail in FIG. 8.

As already described above, the Intra-BSS indication process 507 illustrated in detail in FIG. 8 may be triggered and managed by the sharing AP 110 such that each shared AP 120 (being a member of the current coordination agreement) sends the information 801a,b to its associated non-AP stations 125a-c once per established coordination agreement. In an embodiment, each sharing AP 120 may be required to complete its indication before it can participate with its BSS stations in a coordinated transmission. In an embodiment, all the APs 110, 120 operating under the same coordination agreement may complete their Intra-BSS related indication procedure 507 within more than a single TXOP, such as within the first TXOP 610 and the second TXOP 630 shown in FIG. 6. Embodiments disclosed herein allow to ensure that at the end of a TXOP all the APs 110, 120 under the same coordination agreement know the completion status of the Intra-BSS related indication procedure 507 of all the other APs 110, 120 operating under the same coordination agreement.

In the following a more detailed description of FIG. 6 will be provided. In the scenario illustrated in FIG. 6 four APs, namely AP1, AP2, AP3 and AP4 are members of the coordination agreement. FIG. 6 illustrates an exemplary communication between the four APs during two TXOPs 610, 630 immediately after the establishment of the coordination agreement. The first TXOP 610 is obtained by AP1 (i.e. AP1 is the sharing AP 110 of the first TXOP, while AP2, AP3 and AP4 are shared APs 120) and the second TXOP 630 is obtained by AP2 (i.e. AP2 is the sharing AP 110 of the second TXOP, while AP1, AP3 and AP4 are shared APs 120). At the beginning of the first TXOP 610, all the APs are marked as “not completed” in the completion status table 400. AP1, i.e. the sharing AP1 for the first TXOP 610 wants to share the TXOP resources with AP2 and AP3 for a M-AP coordinated transmission. Thus, according to an embodiment, AP1, i.e. the currently sharing AP 110 based on the status information in table 400 triggers AP2 and AP3 to complete the intra-BSS related indication 507 in the way already described above. When both AP2 and AP3 have sent the complete indication frames 509 and AP1 has performed the intra-BSS indication 507 for its own BSS stations 115a,b, a status update frame 511 is sent to all shared APs operating under the same coordination agreement (to include those APs that have completed the Intra-BSS indication procedure with their BSS). In response to receiving the status update frame 511, all the APs operating under the same coordination agreement, may update their local copies of the completion status table 400, where AP1, AP2 and AP3 are now marked with the status “completed”. Thus, AP1, may perform coordinated transmission 313a with any of AP2 or AP3 as part of the first TXOP 610. For the second TXOP 630, where AP2 is the sharing AP 110, AP2 wants to share its obtained TXOP resources with AP4 (which is one of the shared APs 120). However, because AP4 is still indicated with the status “not completed” in the completion status table 400, the sharing AP2 110 shall trigger the shared AP4 120 to perform the intra-BSS indication 507. Once the shared AP4 120 has transmitted the complete indication frame 509 to the sharing AP2 110, the sharing AP2 110 may send a status update frame 511 to all the APs operating under the same coordination agreement (to include AP1 and AP3 that have already completed their Intra-BSS indication). In response to the status update frame 511, all the APs operating under the same coordination agreement may update their local copies of the completion status table 400, where all the APs are marked as “completed”. From this point onwards (till the expiration of the coordination agreement) any subset of AP1, AP2, AP3, AP4 may initiate a coordinated transmission when any of them becomes the sharing AP (when it obtains the TXOP).

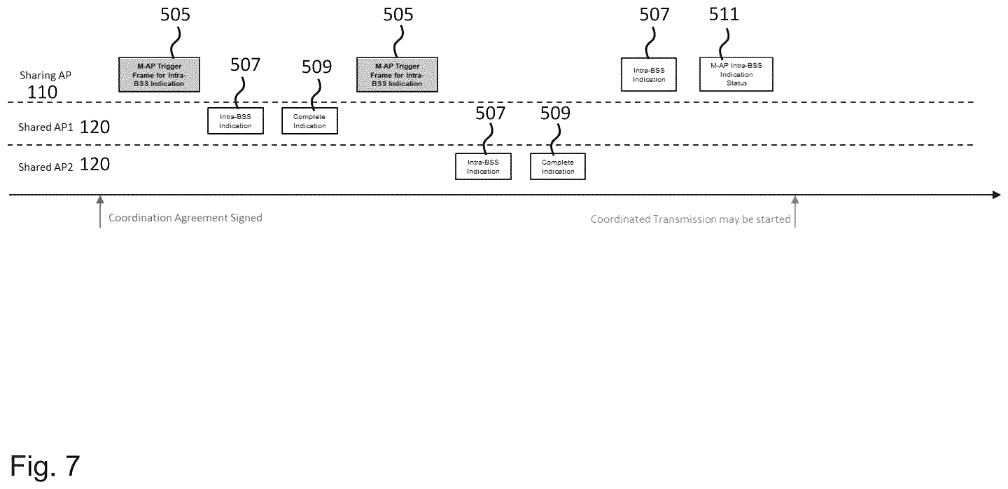

As already described above and illustrated in FIG. 7, the sharing AP 110 may transmit the M-AP trigger frame 505 to each of the shared AP(s) 120 for triggering the respective shared AP 110 to initiate the Intra-BSS indication procedure with its associated non-AP stations, as illustrated in FIG. 8. In an embodiment, the M-AP trigger frame 505 may comprise an address of the triggered shared AP 120, a M-AP set identifier, a coordination agreement identifier and/or a list of APs of the M-AP set.

As illustrated in FIG. 8 and already described above, the AP 120 may send the Intra-BSS indication frame 801a,b to its associated non-AP stations 125a-c.This frame 801a,b may be part of a PPDU (see details below) and may include a M-AP set identifier, a coordination agreement identifier, a list of the involved APs and/or coordination scheme related information. The Intra-BSS indication frame 801a,b illustrated in FIG. 8 may be a dedicated unicast frame. In a further embodiment, the Intra-BSS indication frame 801a,b may be a “multicast”-like frame, such as a broadcast management frame intended for a group of non-AP stations 125a-c which are specified within the frame body.

As already described above and illustrated, for instance, in FIG. 6, the sharing AP 110 may send a M-AP indication status frame 511 to the shared APs 120 for updating all the shared APs 120 operating under the same coordination agreement about the respective completion the status of the Intra-BSS indication procedure 507 of the respective AP. In an embodiment, the M-AP indication status frame 511 may comprise a list of the APs operating under the same coordination agreement, the information about the completion status per AP for updating the local copy of the table 400, a M-AP set identifier, and/or a coordination agreement identifier. In a further embodiment, the M-AP indication status frame 511 may comprise the whole completion status table 400 generated and maintained by the sharing AP 110.

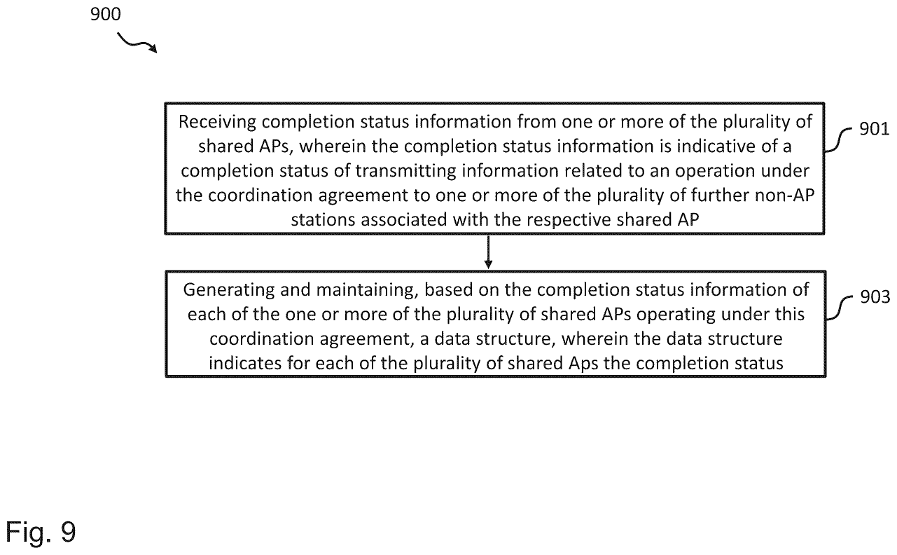

FIG. 9 is a flow diagram illustrating a method 900 of operating the sharing AP 110 according to an embodiment. As already described above, the sharing AP 110 is configured to share at least a portion of a TXOP with the one or more shared AP(s) 120 operating under a coordination agreement within a M-AP set for participating in a coordinated transmission to the one or more non-AP stations 115a-c associated with the sharing AP 110 and the further non-AP stations 125a-c associated with each of the shared AP(s) 120. The method 900 comprises a step 901 of receiving completion status information 509 from one or more of the shared AP(s) 120, wherein the completion status information 509 is indicative of a completion status of transmitting information 801a,b related to an operation under the coordination agreement to one or more of the further non-AP stations 125a-c associated with the respective shared AP 120. Moreover, the method 900 comprises a step 903 of generating and maintaining, based on the completion status information 509 of each of the one or more shared AP(s) 120 operating under the coordination agreement, the data structure 400, wherein the data structure 400 indicates for each of the plurality of shared APs 120 the completion status. As already described above, in an embodiment, the data structure 400 may be a look-up table 400.

As will be appreciated from the detailed description of the sharing AP 110 above, the method 900 may further comprise generating and transmitting one or more M-AP trigger frames, in particular one or more M-AP trigger frames for Intra-BSS indication, to one or more of the plurality of shared APs 120 for triggering, i.e. soliciting the respective shared AP 120 to provide the information related to an operation under the coordination agreement to the one or more further non-AP stations 125a-c associated with the respective shared AP 120.

As the method 900 can be implemented by the sharing AP 110, further features of the method 900 result directly from the functionality of the sharing AP 110 and its different embodiments described above and below.

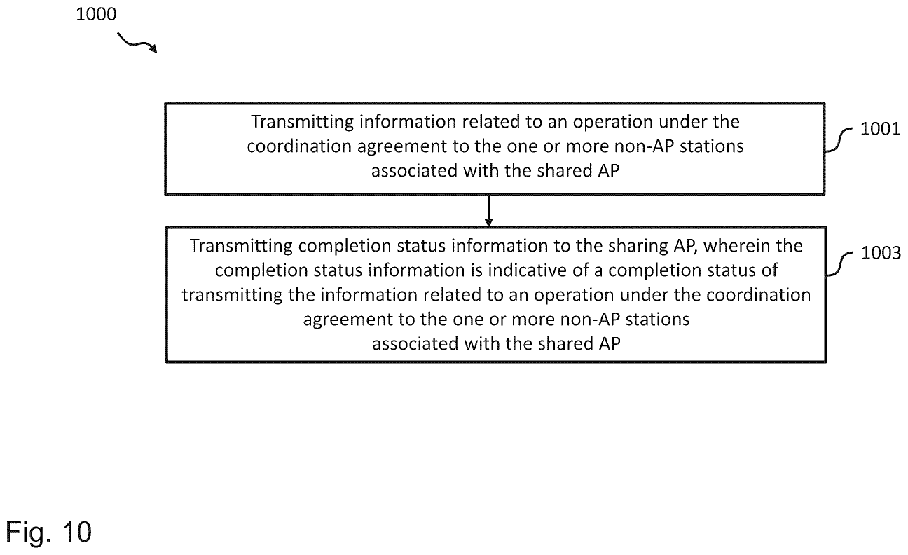

FIG. 10 is a flow diagram illustrating a method 1000 of operating one of the plurality of the shared APs 120 according to an embodiment. As already described above, the shared AP 120 is configured to participate in a coordinated transmission to one or more non-AP stations 125a-c associated with the shared AP 120 and one or more further non-AP stations 115a-c associated with the sharing AP 110 making use of at least a portion of a TXOP obtained and shared by the sharing AP 110 operating under a coordination agreement within a M-AP set. The method 1000 comprises a step 1001 of transmitting information 801a,b related to an operation under the coordination agreement to the one or more non-AP stations 125a-c associated with the shared AP 120. Moreover, the method 1000 comprises a step 1003 of transmitting completion status information to the sharing AP, wherein the completion status information 509 is indicative of a completion status of transmitting the information 801a,b related to an operation under the coordination agreement to the one or more non-AP stations 125a-c associated with the shared AP 120.

As will be appreciated from the detailed description of the shared APs 120 above, the method 1000 may further comprise receiving a M-AP trigger frame from the sharing AP 110 and transmitting the information related to an operation under the coordination agreement to the one or more non-AP stations 125a-c associated with the shared AP 120 following, in particular in response to the reception of the M-AP trigger frame from the sharing AP 110.

As the method 1000 can be implemented by the shared AP 120, further features of the method 1000 result directly from the functionality of the shared AP 120 and its different embodiments described above and below.

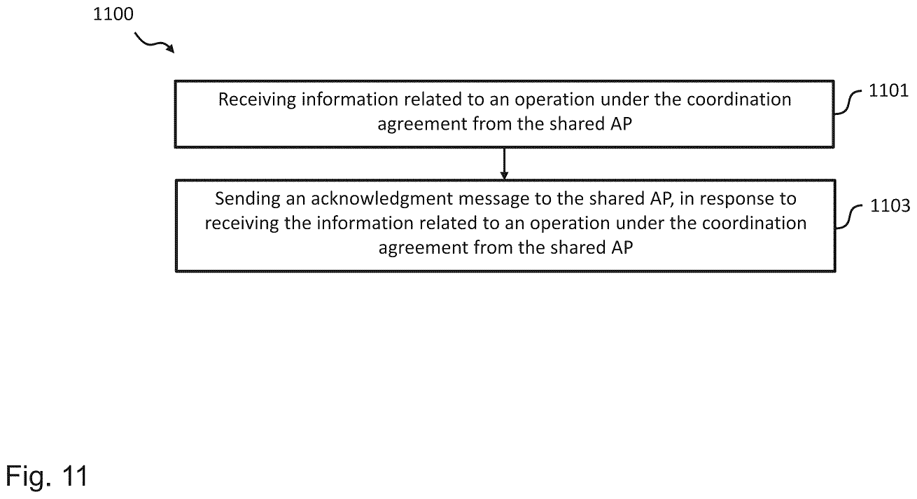

FIG. 11 is a flow diagram illustrating a method 1100 of operating the exemplary non-AP station 125a associated with the shared AP 120 according to an embodiment. As already described above, the shared AP 120 is configured to participate in a coordinated transmission to the non-AP station 125a associated with the shared AP 120 and a plurality of further non-AP stations 115a-c, 125b,c associated with the shared AP 120 or the sharing AP 110 making use of at least a portion of a TXOP obtained and shared by the sharing AP 110 operating under a coordination agreement within a M-AP set. The method 1100 comprises a step 1101 of receiving information 801a related to an operation under the coordination agreement from the shared AP 120. Moreover, the method 1100 comprises a step 1103 of sending an acknowledgment frame 803a to the shared AP 120, in response to successfully receiving the information 801a related to an operation under the coordination agreement from the shared AP 120.

As the method 1100 can be implemented by the non-AP station 125a associated with the shared AP 120, further features of the method 1100 result directly from the functionality of the non-AP station 125a and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. A sharing access point (AP) configured to share at least a portion of a transmission opportunity (TXOP) with a plurality of shared APs operating under a coordination agreement within a Multi-AP (M-AP) set for participating in a coordinated transmission to one or more non-AP stations associated with the sharing AP and a plurality of further non-AP stations associated with the plurality of shared APs, the sharing AP comprising:
a communication interface configured to receive completion status information frame from one or more of the plurality of shared APs. wherein the completion status information is indicative of a completion status of transmitting information related to an operation under the coordination agreement to one or more of the plurality of further non-AP stations associated with the respective shared AP; and
processing circuitry configured to, based on the completion status information frame of each of the one or more of the plurality of shared APs, generate and maintain a data structure that includes the completion status for each of the plurality of shared APs.

2. The sharing AP of claim 1, wherein the communication interface is configured to transmit the data structure to each of the plurality of shared APs.

3. The sharing AP of claim 2, wherein the communication interface is configured to transmit an Indication Status frame to the plurality of shared Aps, and wherein the indication frame comprises the data structure.

4. The sharing AP of claim 3, wherein the Indication Status frame further comprises a MAC address and/or one or more identifiers of one or more of the sharing AP and the plurality of shared APs.

5. The sharing AP of claim 3, wherein the Indication Status frame further comprises a M-AP set identifier indicative of the M-AP set

6. The sharing AP of claim 3, wherein the indication frame further comprises a coordination agreement identifier within the M-AP set, wherein the coordination agreement identifier identifies one coordination agreement of a plurality of coordination agreements within the M-AP set, and wherein the sharing AP and the plurality of shared APs operate under the coordination agreement identified by the coordination agreement identifier within the M-AP set.

7. The sharing AP of claim 1, wherein the data structure comprises an indication of the completion status for each of the plurality of shared APs as well as the sharing AP operating under the same coordination agreement.

8. The sharing AP of claim 1, wherein the data structure comprises a look-up table.

9. The sharing AP of claim 1, wherein the communication interface is further configured to transmit one or more M-AP trigger frames to one or more of the plurality of shared APs for triggering the respective shared AP to provide the information related to an operation under the coordination agreement to the one or more further non-AP stations associated with the respective shared AP.

10. The sharing AP of claim 9, wherein the communication interface is configured to transmit the one or more M-AP trigger frames to the one or more of the plurality of shared APs, for which the data structure indicates that the respective shared AP has not completed an Intra-BSS related procedure, for triggering the respective shared AP to provide the information related to an operation under the coordination agreement to the one or more further non-AP stations of the plurality of further non-AP stations associated with the respective shared AP.

11. The sharing AP of claim 9, wherein the one or more M-AP trigger frames comprise a MAC address and/or an identifier of the sharing AP and/or of each of the plurality of shared APs.

12. The sharing AP of claim 9, wherein the one or more M-AP trigger frames comprise a M-AP set identifier indicative of the M-AP set.

13. The sharing AP of claim 9, wherein the one or more M-AP trigger frames comprise a coordination agreement identifier within the M-AP set, wherein the coordination agreement identifier identifies one coordination agreement of a plurality of coordination agreements within the M-AP set, and wherein the sharing AP and the plurality of shared APs operate under the coordination agreement identified by the coordination agreement identifier within the M-AP set.

14. The sharing AP of claim 1, wherein the processing circuitry is configured to restrict the coordinated transmission to those of the plurality of shared APs, for which the sharing AP has indicated their status information as being completed.

15. The sharing AP of claim 1, wherein the information related to an operation under the coordination agreement comprises a M-AP set identifier indicative of the M-AP set.

16. The sharing AP of claim 1, wherein the information related to an operation under the coordination agreement comprises a coordination agreement identifier within the M-AP set, wherein the coordination agreement identifier identifies one coordination agreement of a plurality of coordination agreements within the M-AP set, and wherein the sharing AP and the plurality of shared APs operate under the coordination agreement identified by the coordination agreement identifier within the M-AP set.

17. The sharing AP of claim 1, wherein the information related to an operation under the coordination agreement comprises a MAC address and/or an identifier of each of the plurality of shared APs.

18. The sharing AP of claim 1, wherein the sharing AP further comprises a memory, wherein the memory is configured to store the data structure.

19. A method of operating a sharing access point (AP) configured to share at least a portion of a transmission opportunity (TXOP) with a plurality of shared APs operating under a coordination agreement within a Multi-AP (M-AP) set for participating in a coordinated transmission to one or more non-AP stations associated with the sharing AP and a plurality of further non-AP stations associated with the plurality of shared APs, the method comprising:
receiving a completion status information frame from one or more of the plurality of shared APs, wherein the completion status information frame is indicative of a completion status of transmitting information related to an operation under the coordination agreement to one or more of the plurality of further non-AP stations associated with the respective shared AP; and
generating and maintaining, based on the completion status information frame of each of the one or more of the plurality of shared APs operating under the coordination agreement, a data structure that indicates, for each of the plurality of shared APs, the completion status.

20. The method of claim 19, further comprising transmitting one or more M-AP trigger frames to one or more of the plurality of shared APs for triggering the respective shared AP to provide the information related to an operation under the coordination agreement to the one or more further non-AP stations associated with the respective shared AP.

21. A shared access point (AP) configured to participate in a coordinated transmission to one or more non-AP stations associated with the shared AP and one or more further non-AP stations associated with a sharing AP making use of at least a portion of a transmission opportunity (TXOP) obtained and shared by the sharing AP operating under a coordination agreement within a Multi-AP (M-AP) set, the shared AP comprising:
a communication interface configured to;
transmit information related to an operation under the coordination agreement to the one or more non-AP stations associated with the shared AP, and
transmit completion status information frame to the sharing AP, wherein the completion status information frame is indicative of a completion status of transmitting the information related to an operation under the coordination agreement to the one or more non-AP stations associated with the shared AP.

22. The shared AP of claim 21, wherein the communication interface is further configured to receive a data structure from the sharing AP, wherein the data structure indicates for the sharing AP and for each of a plurality of further shared APs operating under the coordination agreement within the M-AP set the completion status of transmitting the information related to an operation under the coordination agreement to one or more non-AP stations associated with the sharing AP or the respective further shared AP.

23. The shared AP of claim 22, wherein the communication interface is configured to receive an indication frame from the sharing AP and wherein the Indication Status frame comprises the data structure.

24. The shared AP of claim 23, wherein the Indication Status frame further comprises an address and/or an identifier of the sharing AP and/or the shared AP.

25. The shared AP of claim 23, wherein the Indication Status frame further comprises an M-AP set identifier indicative of the M-AP set.

26. The shared AP of claim 23, wherein the Indication Status frame further comprises a coordination agreement identifier within the M-AP set, wherein the coordination agreement identifier identifies one coordination agreement of a plurality of coordination agreements within the M-AP set, and wherein the sharing AP and the plurality of shared APs operate under the coordination agreement identified by the coordination agreement identifier within the M-AP set.

27. The shared AP of claim 22, wherein the data structure comprises an indication of the completion status for each of the plurality of shared APs operating under the same coordination agreement.

28. The shared AP of claim 22, wherein the data structure comprises a look-up table.

29. The shared AP of claim 21, wherein the communication interface is configured to transmit the information related to an operation under the coordination agreement to the one or more non-AP stations associated with the shared AP, following the reception of a M-AP trigger frame from the sharing AP.

30. The shared AP of claim 29, wherein the M-AP trigger frame comprises a MAC address and/or an identifier of the sharing AP and/or of each of the plurality of shared APs.

31. The shared AP of claim 29, wherein the M-AP trigger frame comprises a M-AP set identifier indicative of the M-AP set.

32. The shared AP of claim 29, wherein the M-AP trigger frame comprises a coordination agreement identifier within the M-AP set, wherein the coordination agreement identifier identifies one coordination agreement of a plurality of coordination agreements within the M-AP set and wherein the sharing AP and the shared AP operate under the coordination agreement identified by the coordination agreement identifier within the M-AP set.

33. The shared AP of claim 21, wherein the information related to an operation under the coordination agreement comprises a M-AP set identifier indicative of the M-AP set.

34. The shared AP of claim 21, wherein the information related to an operation under the coordination agreement comprises a coordination agreement identifier within the M-AP set, wherein the coordination agreement identifier identifies one coordination agreement of a plurality of coordination agreements within the M-AP set and wherein the sharing AP and the shared AP operate under the coordination agreement identified by the coordination agreement identifier within the M-AP set.

35. The shared AP of claim 21, wherein the information related to an operation under the coordination agreement comprises an address and/or an identifier of the shared AP and one or more further shared APs operating under the same coordination agreement within the M-AP set.

36. The shared AP of claim 21, wherein the shared AP further comprises a memory, wherein the memory is configured to store the data structure.

37. The shared AP of claim 21, wherein the communication interface is further configured to receive an acknowledgement frame from each of the one or more non-AP stations associated with the shared AP, in response to transmitting the information related to an operation under the coordination agreement to the one or more non-AP stations associated with the shared AP.

38. A method of operating a shared access point (AP) configured to participate in a coordinated transmission to one or more non-AP stations associated with the shared AP and one or more further non-AP stations associated with a sharing AP making use of at least a portion of a transmission opportunity (TXOP) obtained and shared by the sharing AP operating under a coordination agreement within a Multi-AP (M-AP) set, the method comprising:
transmitting information related to an operation under the coordination agreement to the one or more non-AP stations associated with the shared AP; and
transmitting completion status information frame to the sharing AP, wherein the completion status information is indicative of a completion status of transmitting the information related to an operation under the coordination agreement to the one or more non-AP stations associated with the shared AP.

39. The method of claim 38, further comprising receiving a M-AP trigger frame from the sharing AP and transmitting the information related to an operation under the coordination agreement to the one or more non-AP stations associated with the shared AP following the reception of the M-AP trigger frame from the sharing AP.

40. A non-access point (non-AP) station associated with a shared AP, wherein the shared AP is configured to participate in a coordinated transmission to the non-AP station associated with the shared AP and a plurality of further non-AP stations associated with the shared AP or a sharing AP making use of at least a portion of a transmission opportunity (TXOP) obtained and shared by the sharing AP operating under a coordination agreement within a Multi-AP (M-AP) set, wherein the non-AP station comprises:
a communication interface configured to:
receive information related to an operation under the coordination agreement from the shared AP, and
send an acknowledgment frame to the shared AP, in response to receiving the information related to an operation under the coordination agreement from the shared AP.

41. The non-AP station of claim 40, wherein the information related to an operation under the coordination agreement comprises a M-AP set identifier indicative of the M-AP set.

42. The non-AP station of claim 40, wherein the information related to an operation under the coordination agreement comprises a coordination agreement identifier within the M-AP set, wherein the coordination agreement identifier identifies one coordination agreement of a plurality of coordination agreements within the M-AP set and wherein the sharing AP and the shared AP operate under the coordination agreement identified by the coordination agreement identifier within the M-AP set.

43. The non-AP station of claim 40, wherein the information related to an operation under the coordination agreement comprises a MAC address and/or an identifier of the shared AP.

44. A method of operating a non-access point (AP) station associated with a shared AP, wherein the shared AP is configured to participate in a coordinated transmission to the non-AP station associated with the shared AP and a plurality of further non-AP stations associated with the shared AP or a sharing AP making use of at least a portion of a transmission opportunity (TXOP) obtained and shared by the sharing AP operating under a coordination agreement within a Multi-AP (M-AP) set, the method comprising:
receiving information related to an operation under the coordination agreement from the shared AP; and
sending an acknowledgment frame to the shared AP, in response to receiving the information related to an operation under the coordination agreement from the shared AP.

45. A non-transitory computer-readable medium having stored thereon processor executable instructions that, when executed by processing circuitry, cause the processing circuitry to perform the method of claim 19.
